(19) United States
(12) Patent Application Publication
(10) Pub. No.: US 2007/0095036 A1
(43) Pub. Date: May 3, 2007

(54) Apparatus and method for filtering particulate from high temperature gas streams using a composite filter.

(75) Inventor: Peter Steinar Dahlberg, Salt Lake City, UT (US)

Correspondence Address: PETER S. DAHLBERG, 8364 S. AUSTRIAN WAY, SALT LAKE CITY, UT, 84121, US

(73) Assignee: Peter Steinar Dahlberg, Salt Lake City, UT (US)

(21) Appl. No.: 11/163,859

(22) Filed: Nov. 1, 2005

(51) Int. Cl. B01D 46/32

(52) U.S. Cl. 55/474

(57) ABSTRACT

This disclosure describes an apparatus which will enable high temperature filtration of particulate laden gases through a composite filter that consists of a layer of in-expensive granular filter media that is supported on a high temperature porous media. It also describes a method for regenerating the composite filter media when the pressure drop across said media becomes too high. The purpose of such a high temperature composite filter is to inexpensively facilitate the filtration of high temperature gases bearing sticky particulate in a low pressure drop continuous and reliable manner. Particulate from hot gases are captured by the granular filter media. When the pressure drop across a filter element becomes too high, a reverse flow of gas through the high temperature porous media causes the granular media to slide down the inclined porous media. New granular media is introduced at the top of the inclined filter element to replace granular media that is discharged from the bottom end of the inclined filter element.

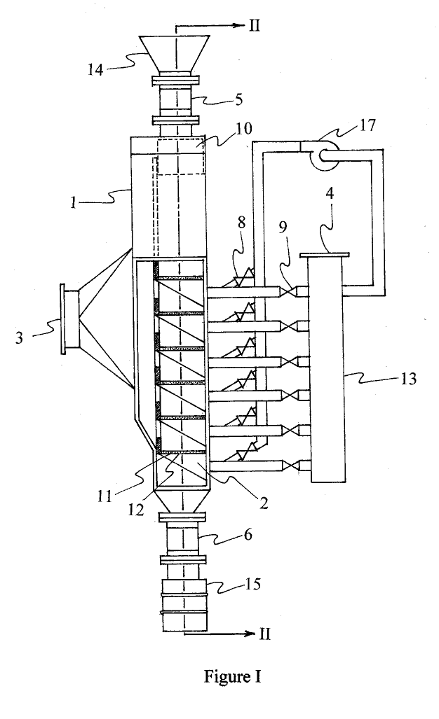

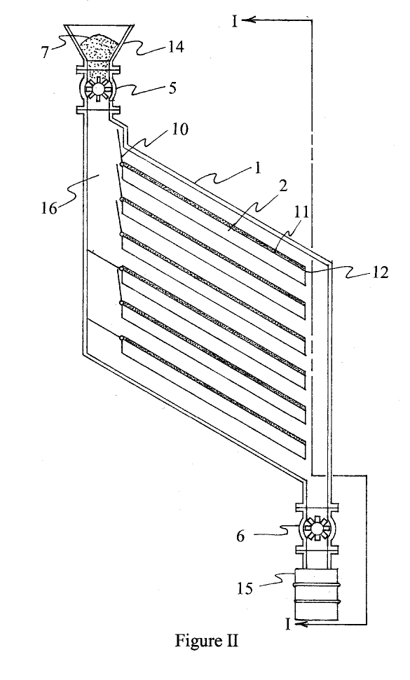

### REFERENCES CITED

U.S. Pat. No. 6,783,572 November 2002 Squires

### STATEMENT REGARDING FEDERAL SPONSORED RESEARCH AND DEVELOPMENT

This invention is not the result of any federally sponsored research or development funding.

### BACKGROUND OF THE INVENTION

The removal of fine particulate from high-temperature gas streams has been sought after for many processes. Metallurgical plants can use high-temperature particulate filtering for separation of elements that are volatile at low temperature such as arsenic and mercury. Coal gasification plants could realize substantial energy efficiency improvements if syn-gas is processed at high temperature. Much work has been done to develop high temperature membrane filters that are made of ceramic or exotic metals with some success. However, the current generation of membrane filters suffer from high capital and operating cost. The pressure drop across these filters can be high and unpredictable. Numerous elements and/or compounds found in gas streams that are candidates for high temperature filtration can plug the small passages in high temperature membrane filters causing subsequent filtration to cease. Removing the plugging elements and/or compounds is often difficult or not practical. Moving bed granular filters address some of the drawbacks of high temperature membrane filters such as high cost and high and unpredictable pressure drop. However, moving bed granular filters are not able to achieve the same level of particulate removal as high temperature membrane filters making additional particulate cleaning necessary. Electrostatic precipitators can remove particulate at high temperature but are not suitable for treating combustible gases such as syn-gas from coal gasification because of the high potential for fires and explosions.

A composite filter media consisting of a high temperature porous media and a layer of granular filter material filters gas at high temperature with low predictable pressure drops and high particulate removal efficiency. Capital and operating costs are also less than alternative systems.

### SUMMARY OF THE INVENTION

The invention disclosed herein is an Apparatus and Method for filtering particulate from high temperature gas streams using a composite filter. The Apparatus used to achieve this combines in a novel manner, a device well known for conveying material, an air slide, with a new concept in high temperature particulate filtration, a composite particulate filter element.

Hot particulate laden gas enters the filter housing through a flanged nozzle. The filter housing contains multiple filter elements that are arranged so that they are stacked vertically. A filter housing may contain several rows of stacked filter elements depending on the capacity required by the process. The filter elements consist of a planar high temperature filter media that is rectangular in shape with dimensions that vary to suit the application. Generally the width of the filter media is 0.1 to 0.03 times the length of the filter media. The filter media is level in the width dimension and slopes in the length direction. The filter media is a composite that consists of a high temperature porous media that is made of either ceramic, sintered metal powder or sintered metal wire. On top of this membrane is a layer of inexpensive granular ceramic material such as sand or absorbent or a combination of sand and absorbent. The hot particulate laden gas passes through this granular filter material where the particulate is removed from the gas stream. The mechanisms for particulate removal include:

Sieving—a layer of particulate forms on the granular media. This particulate layer becomes a sieve for subsequent particulate removal.

Inertial impaction—a dust particle has momentum that prevents it from following a curved streamline around a granule and its inertia carries it into the granule where it impacts the granule surface and sticks.

Diffusion—Brownian motion of a dust particle superimposed on the bulk flow of the gas cause the particle to migrate into a quiet void between granules where the particle is captured.

Electrostatic attraction—particles carrying a different electrostatic charge than bed granules will be attracted to the granules.

If an absorbent is mixed with or used in place of granular filter media, gas constituents are absorbed simultaneously with particulate removal. Cleaned gas passes through the porous media and out of the filter housing to down stream operations.

The pressure drop across the composite filter media increases steadily as the media captures particulate. When the pressure has increased to an un-acceptable level, the filter media is regenerated to return the pressure drop across the composite filter media to initial levels. Regeneration of the media is accomplished as follows: Only one filter element within the filter housing is regenerated at a time. Closing a clean gas isolation valve on the clean side of the filter element stops flow of particulate laden gas. Another valve is opened that causes clean gas to flow in the reverse of normal direction through the filter media. The reverse flow through the filter media causes the granular filter material that is above the porous media to become fluidized. The fluidized granular material slides down the sloped porous media. At the end of the filter element, the granular filter material is discharged into a chute and falls to a hopper in the base of the filter housing. The granular filter material is discharged from the hopper through a rotary air lock. The spent granular filter material is either discarded or regenerated and reused depending on the particular application.

As the spent granular filter material slides down the porous media, new granular material is fed with a rotary air lock onto the high end of the filter element where it slides down the porous media. When all of the spent granular filter material has been displaced with new granular filter material, the reverse flow of gas is stopped by closing the reverse flow valve, and opening the clean gas isolation valve. The rotary air lock that feeds new granular filter material is simultaneously stopped. Filtration through the regenerated filter element resumes. All of the filter elements are regenerated sequentially as described above. An adjustable time period of varying duration exists between the end of filter element regeneration and the beginning of the subsequent filter element regeneration cycle. The duration of this time period depends on specific process conditions, and can be set automatically based on the pressure drop across the filter elements, using computer control.

Gas flow through the filter housing is constant even during filter element regeneration. During filter element regeneration, gas flow is increased through the other filter elements within the housing to process the gas that is normally processed by the element being regenerated in addition to processing the gas that back flows through the filter element that is being regenerated.

In summary, this invention therefore combines in a novel manner, a simple high temperature porous media and an air slide for regeneration of granular filter media. It further provides an apparatus and method for refreshing the composite granular filter media when the pressure drop across the granular filter media becomes too high. As a whole, this invention provides a useful, novel and non-obvious Apparatus and Method for filtering particulate from high temperature gas streams using a composite filter.

### BRIEF DESCRIPTION OF THE DRAWINGS

FIGS. I and II are sectional views through a filter housing, and depict the key elements of the invention, embodied in a filter housing that houses composite filter elements that form a filtration barrier through which particulate laden gas must pass such that the particulate is deposited on the composite filter element surface and cleaned gas flows into a clean gas chamber. Also, depicted are the key elements required for regeneration of the composite filter elements including: reverse gas valves, filter element isolation valves, granular media rotary air locks, granular media chutes and granular media diverter gates.

FIGS. I and II depict the key elements of the invention with two different views, embodied in a filter housing 1 that houses composite filter elements 2.

Hot particulate laden gas enters the filter housing 1 through dirty gas inlet 3. The gas flows evenly through each of the filter elements contained in the filter housing. As the gas is passing through the composite filter element, it first passes through granular media 11 where the particulate is removed from the gas stream utilizing four mechanisms which are sieving, inertial impaction, diffusion and electrostatic attraction. The gas then passes through the porous media 12 which supports the granular media 11. On the clean side of the media the gas passes through a pipe and normally open filter element isolation valve 9 into a clean gas plenum 13 and then is discharged through clean gas outlet 4. The gas is induced to flow from the dirty gas inlet 3 to the clean gas outlet 4 because the pressure is lower at clean gas outlet 4 than it is at dirty gas inlet 3. This difference in pressure is induced by a device in the process stream such as a fan, compressor, or blower which are well known devices, are not an integral part of this invention and are not depicted here.

Particulate matter that is collected on granular media 11 cause the pressure difference between dirty gas inlet 3 and clean gas outlet 4 to increase. If the particulate matter is allowed to build up indefinitely, then the pressure difference would increase causing the volume capacity of the gas inducing device to decrease. To maintain acceptable flow and pressure difference, the composite granular filter elements must be regenerated. Regeneration of the granular filter elements is accomplished in the following manner: Instruments that are well known and commonly available measure the pressure difference between dirty gas inlet 3 and clean gas outlet 4. When the pressure difference reaches a predetermined level or set point, that is adjustable between 0.5 and 50 inches of water column, a regeneration cycle is initiated by a computer. This computer is a well known commercially available device commonly referred to as a Programmable Logic Controller or PLC. The PLC as well as the PLC monitored or controlled devices including actuators, electrical motor switches and instruments are not depicted as they are commonly available in numerous variations to facilitate PLC opening and closing of valves and the starting and stopping of motors. The PLC controls the regeneration of each composite granular filter element, one element at a time in sequence. The sequence is interrupted when the pressure difference falls below the set-point and then is resumed, where it was interrupted, when the pressure difference increases above the set-point. The order in which the granular filter elements are regenerated is not important as long as the next element to be regenerated is the element that has been filtering for the longest time since it was last regenerated.

Regeneration Cycle: To start regeneration, a diverter valve 10 corresponding to the element to be regenerated is moved to a position, by the PLC, that causes granular media that is falling through fresh granular media chute 16 and be diverted onto the element to be regenerated. Recirculation blower 17 and spent granular media rotary air lock 6 are started by the PLC. Fresh granular media rotary air lock 5 is started by the PLC which starts the flow of fresh granular filter media 7 down chute 16. At the instant that the fresh granular media reaches the filter element to be regenerated, normally open filter element isolation valve 9 closes and normally closed filter element regeneration valve 8 opens. A flow of cleaned gas flows in reverse direction through porous media 12 causing the spent granular media 11 to become fluidized and flow down the filter element 2, through spent granular media rotary air lock 6 and into storage vessel 15. When all of the spent granular media has been replaced with fresh granular media, the PLC stops fresh granular media rotary air lock 5 then opens normally open filter element isolation valve 9 and closes normally closed filter element regeneration valve 8 and the regenerated element is in service filtering hot gases. After a short time delay to ensure that all spent granular media has been discharged from filter housing 1, spent granular media rotary air lock 6 is shut off. Assuming that the cleaning of one element has caused the pressure difference between dirty gas inlet 3 and clean gas outlet 4 to return to acceptable level, the PLC turns off recirculation blower 17. After a period of time, when the pressure difference between dirty gas inlet 3 and clean gas outlet 4 again increases to a level that exceeds the set point, the regeneration cycle is resumed starting with the next filter element in the sequence.

Finally, it is emphasized that while this disclosure discusses the essential elements of an apparatus and method for filtering particulate from high temperature gas streams using a composite filter, one could design the invention disclosed herein using a variety of materials of construction to suit particular applications, for example with very high temperature gas streams, all of the surfaces that contact the hot gases could be lined or made with refractory materials including porous media 12 that are compatible with the specific process requirements. Further, numerous varieties of controls could be used to achieve the same control as the PLC. Likewise, there are numerous devices that will serve the same function and could be used in place of the rotary air locks 5 and 6.

What is claimed is:

1. A hot gas cleaning system including: a filter element vessel having a hot gas inlet, a hot gas outlet, a fresh granular media inlet and a spent granular media outlet; a dirty gas chamber within said vessel in gas flow communication with said hot gas inlet; a clean gas chamber within said vessel in gas flow communication with said hot gas outlet; a number of composite filter assemblies separating the clean gas chamber from the dirty gas chamber with assemblies arranged in a vertical stack.

2. The hot gas cleaning system of claim 1 wherein the composite filter consists of a high temperature porous media that is made of either ceramic sintered metal powder, or sintered metal wire and a layer on top of the porous media consisting of granular material.

3. The hot gas cleaning system of claim 2 wherein the granular material consists of either slag, sand, ground minerals, absorbents, adsorbents, metal particles, chemical precipitates, ground refractories, soil or any combination of the above with the main properties being small size (less than 10 mesh) and a melting temperature that is higher than the hot gas being cleaned.

4. The hot gas cleaning system of claim 2 wherein the granular material filters the gas forming a filter cake that then filters the gas while the high temperature porous media does not filter particulate but supports the granular material and allows cleaned gas to pass through it.

5. The hot gas cleaning system of claim 1 wherein the composite filter is regenerated by reversing the flow of clean gas causing the spent granular material to slide down the porous media and off of the low end of the composite filter assembly while fresh granular material is added to the high end of the composite filter assembly where it slides down the porous media replacing spent granular material.

6. The hot gas cleaning system of claim 1 where the clean granular material is introduced into filter element vessel during composite filter element regeneration using a well known material handling device commonly referred to as a rotary air lock, the clean granular material falls down a chute where it is diverted onto any of the composite filter assemblies using a hinged diverter gate that is dedicated, one diverter gate per filter assembly, except the lowest composite filter assembly in the composite filter assembly stack does not require a diverter gate.

7. The hot gas cleaning system of claim 1 where the spent granular material from each composite filter assembly slides into and down a chute that is common for all composite filter assemblies during composite filter element regeneration and is discharged from the filter element vessel using a well known material handling device commonly referred to as a rotary air lock.

8. The hot gas cleaning system of claim 1 where composite filter elements are regenerated sequentially one at a time so that the flow of hot gas through the hot gas cleaning system is uninterrupted.
